(19) United States
(12) Patent Application Publication
(10) Pub. No.: US 2005/0152224 A1
(43) Pub. Date: Jul. 14, 2005

(54) Device and method for automatically adjusting time of analog watch in analog watch-mounted terminal

(75) Inventors: Doo-Sik Shin, Seongnam-si (KR); Jae-Sun Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/933,703

(22) Filed: Sep. 3, 2004

(30) Foreign Application Priority Data
Jan. 12, 2004 (KR) 2004-2030

(51) Int. Cl. G04B 19/22

(52) U.S. Cl. 368/47

(57) ABSTRACT

A device and a method for automatically adjusting the time of an analog watch in an analog watch-mounted terminal are disclosed. The method comprises the steps of: sensing by a sensor a predetermined time for adjusting the time of the analog watch; determining if a predetermined time-adjusting cycle has occurred when the interrupt signal is input from the sensor; and comparing the system time with the present analog time, in the case of a time-adjusting cycle, and transmitting a drive signal to an analog watch drive unit for the purpose of driving the hour hand and the minute hand according to the difference between the times.

### PRIORITY

This application claims priority to an application entitled “DEVICE AND METHOD FOR AUTOMATICALLY ADJUSTING TIME OF ANALOGUE WATCH IN ANALOGUE WATCH-MOUNTED TERMINAL” filed in the Korean Industrial Property Office on Jan. 12, 2004 and assigned Serial No. 2004-2030, the contents of which are hereby incorporated by reference.

### BACKGROUND OF THE INVENTION

1. Field of the Invention

The present invention relates to a device and a method for adjusting the time of an analog watch in an analog watch-mounted terminal and more particularly to a device and a method for automatically adjusting the time of an analog watch in an analog watch-mounted terminal.

2. Description of the Related Art

Recently, communication terminals for use in various sound and data communications such as cellular phones and portable data terminals such as notebook computers have been upgraded and diversified in their functions, as well as have become smaller for greater portability and convenience in use.

In general, the terminals have a function and a structure for providing time information to users. For example, a mobile communication terminal using a CDMA (Code Division Multiple Access) method provides a basic service function, wherein it receives from a base station information related to the present time as soon as the user turns the mobile communication terminal on, and displays the present time through an incorporated LCD (Liquid Crystal Display) unit. Additionally, a terminal such as a mobile communication terminal using the European GSM (Global System for Mobile telecommunication) method, or a terminal such as a notebook computer, provides a basic service function, wherein the user sets the time and the clock displays self-calculated time information at one side of the LCD monitor.

Thus, according to the time service of the terminal, the present time is displayed as a number or an icon in the shape of a watch on an LCD, or the like. The terminal is regarded as utilizing a function and a structure of a general digital watch. However, the users of the aforesaid terminals increasingly demand the time service to not be displayed as a digital watch but by a general analog watch. The analog watch-mounted terminal has the advantage in that it meets the gradually increasing users' preferences for the aesthetic design of an analog watch, and it is capable of providing the time service even in a “no-service” zone, particularly in the case that the terminal receiving the time information from a base station, such as a mobile communication terminal, utilizes an analog watch.

An analog watch generally needs a stem structure protruded from one side thereof for adjusting the time. As shown in FIG. 1, an analog watch 102 is mounted on a mobile communication terminal 100, and a stem 104 for adjusting the time is disposed at one side of the terminal 100. Conventionally, the user rotates the stem in order to adjust the time of an analog watch, wherein the stem is connected to a mechanism for moving the hands installed in the watch and the hands of the watch are moved as the mechanism is rotated by the rotation of the stem so that the time can be adjusted. Accordingly, when an analog watch is mounted on an mobile communication terminal, the structure is aesthetically unfavorable, because the stem protrudes from one side of the watch in other words from one side of the terminal. Moreover, the protruding stem is susceptible to impact. In addition, the said analog watch-mounted terminal is not convenient to use in comparison with a conventional digital watch-mounted terminal, because the user must rotate the stem manually in order to adjust the time.

Therefore, the technology for removing the stem disposed at the outside and adjusting the time of the analog watch by the time input through the user interface is disclosed in the prior art. However, the user has to operate the user interface directly, whenever it is desired to adjust the time, in order to adjust the time of the analog watch by the time input from the user.

As described above, when an analog watch is mounted on a mobile communication terminal, etc., the stem has a structure wherein it protrudes from one side of the watch in other words, from one side of the terminal—and thus the design of the terminal is limited and the adjustment to the correct time is difficult. Additionally, the method for removing the stem and adjusting the time of the analog watch by the time input through the user interface is complicated, because the user must directly operate the user interface of the terminal.

### SUMMARY OF THE INVENTION

Accordingly, the present invention has been made to solve the above-mentioned and other problems occurring in the prior art, and an object of the present invention is to provide a device and a method for automatically adjusting the time of an analog watch in an analog watch-mounted terminal.

Another object of the present invention is to provide a device and a method for adjusting the time of an analog watch in an analog watch-mounted terminal by using the mobile communication system time.

In order to accomplish the above and other objects, there is provided a device for adjusting the time of an analog watch in an analog watch-mounted terminal, the device comprising: a radio unit for receiving a system time from a base station; an analog watch drive unit for driving an hour hand and a minute hand of the analog watch to adjust the time of the analog watch; a sensor attached at a predetermined position for sensing a predetermined time and outputting an interrupt signal; and a control unit for comparing the system time with a current analog time and transmitting a drive signal to an analog watch drive unit for adjusting the hour hand and the minute hand according to the difference between the system time and the current analog time, when the interrupt signal is input from the sensor.

In accordance with another aspect of the present invention, there is provided a method for adjusting the time of an analog watch in an analog watch-mounted terminal that receives a system time from a base station, comprising the steps of: sensing by a sensor a predetermined time to adjust the time of the analog watch; determining if a predetermined time-adjusting cycle has occurred when the interrupt signal is inputted from the sensor; and comparing the system time with the current analog time, and transmitting a drive signal to the analog watch drive unit adjusting an hour hand and a minute hand according to the difference between the system time and the current analog time.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional analog watch-mounted terminal;

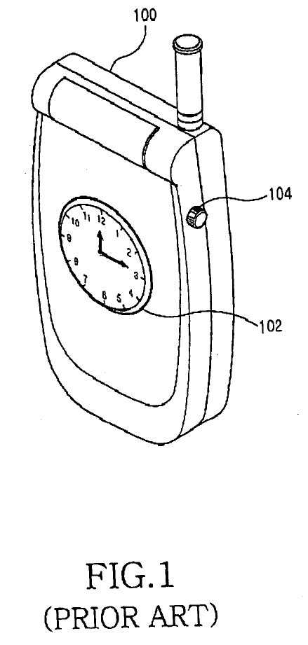

FIG. 2 is a block diagram of the analog watch-mounted terminal according to a preferred embodiment of the present invention;

FIG. 3 is a flow chart for automatically adjusting the time of analog watch in an analog watch-mounted terminal according to a preferred embodiment of the present invention; and

FIG. 4 is a diagram illustrating a process for automatically adjusting the time of analog watch in an analog watch-mounted terminal according to a preferred embodiment of the present invention.

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it will be apparent to those skilled in the art that the present invention can be implemented without such definitions. Further, in the following description of the present invention, a detailed description of known functions and configurations incorporated herein will be omitted when it may obscure the subject matter of the present invention.

According to the present invention, the time of an analog watch is automatically adjusted to a correct communication system time at predetermined cycles without a need for direct adjustment of the time by the user.

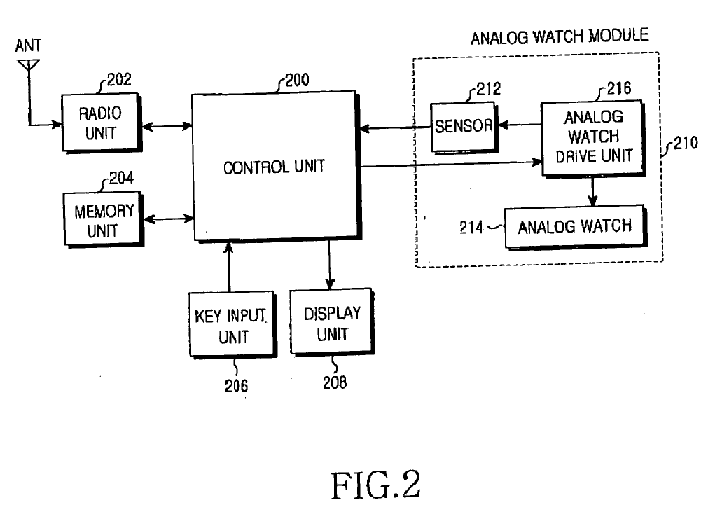

Referring to FIG. 2, the mechanism for automatically and periodically adjusting the time of an analog watch in an analog watch-mounted mobile communication terminal will now be described. FIG. 2 is a block diagram of an analog watch-mounted terminal wherein the time of analog watch is automatically adjusted according to a preferred embodiment of the present invention.

First, the analog watch-mounted terminal comprises a control unit 200, a radio unit 202, a memory unit 204, a key input unit 206, a display unit 208 and an analog watch module 210.

The control unit 200 controls the general actions of the mobile communication terminal. Particularly, according to the present invention, the control unit 200 carries out the control actions so that the time of analog watch 214 can be automatically adjusted. The radio unit 202 process the transmission/reception signals for the wireless communication with a base station. In addition, the system time information received through the radio unit 202 is utilized to adjust the time of analog watch. The memory unit 204 permanently or temporarily stores the action program for operating the mobile communication terminal and the data needed therefore. Particularly, according to the present invention, the memory unit 204 stores the action program for automatically adjusting the time of the analog watch and any related data. The key input unit 206 comprises numeric keys of “1”-“0” and various function keys, such as “menu”, “communication”, “deletion”, “end”, “*”, “# “and “volume”, and provides the key input data corresponding to a pushed key to the control unit 200. The display unit 208 displays the image information on a screen. The control unit 200 recognizes the correct system time received from the radio unit 202, when the signal for adjusting the time of analog watch is input, and transmits the drive signal for adjusting the time of the analog watch drive unit 216. Then, the analog watch drive unit 216 adjusts the time of analog watch 214 according to the drive signal received from the control unit 200. In particular, the sensor 212 for sensing the hour hand of analog watch 214 is attached to the position corresponding to the hour hand of a predetermined time. For example, in the case where the sensor 212 is attached to the position corresponding to three o'clock, the sensor 212 recognizes that it is three o'clock, when the hour hand is positioned at three o'clock, and then the sensor 212 outputs the adjusting signal, that is the interrupt signal for adjusting the time, to the control unit 200. Then, the control unit 200 receives the adjusting signal and checks the cycle for adjusting the time. The control unit 200 checks the cycle for adjusting the time as it receives the interrupt signal from the sensor 212. For example, the time may be adjusted whenever the interrupt signal is input from the sensor 212, or whenever the interrupt signal is input twice from the sensor 212. Accordingly, the user can predetermine the cycle for adjusting the time of analog watch. For example, the user may preset such a cycle that the time is adjusted whenever the interrupt signal is input from the sensor 212 in order to adjust the time twice a day; that the time is adjusted whenever the interrupt signal is input twice in order to adjust the time once a day; or that the time is adjusted whenever the interrupt signal is input fourteen times in order to adjust the time once a week.

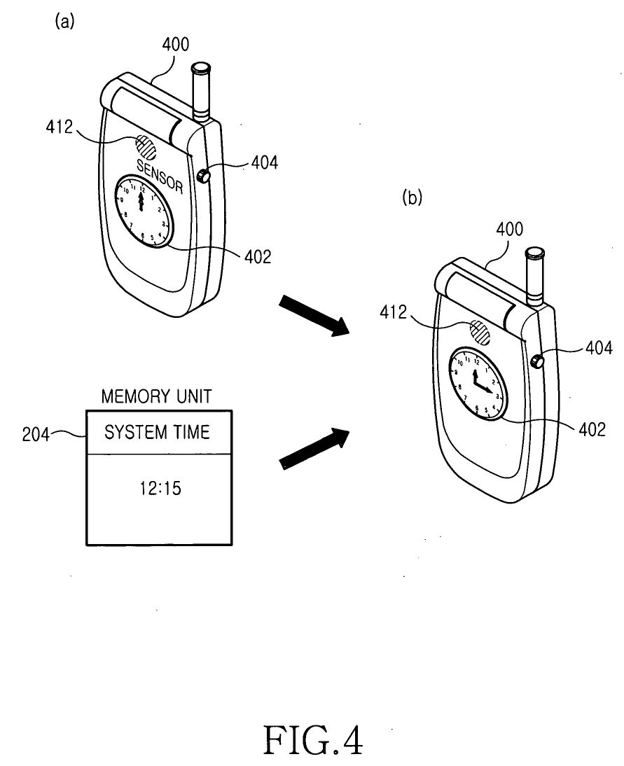

The analog watch module 210 will be explained hereinafter in detail. The analog watch module 210 comprises a sensor 212 for sensing the time of the analog watch 214, an analog watch drive unit 216 for driving the analog watch, and the analog watch 214 comprising the hands for displaying the time, such as the hour hand, the minute hand and the second hand, and various gears. Particularly, the sensor 212 mounted on the analog watch module 210 outputs the interrupt signal to the control unit 200, when the hour hand of the watch is correctly arrived at the position of the sensor, so that the time can be automatically adjusted. For example, as shown in diagram (a) of FIG. 4, in the case where the sensor 212 is attached to the position corresponding to twelve o'clock, the sensor 212 outputs the interrupt signal to the control unit 200 every twelve hours, when the hour hand of analog watch 214 is positioned at twelve o'clock. The control unit 200 calculates the difference between the system time received through the radio unit 202 and the present time, i.e., twelve o'clock, as soon as the interrupt signal is input. Additionally, the control unit 200 transmits the drive signal to the analog watch drive unit 216, so that the time of analog watch 214 can be adjusted according to the difference calculated between the correct time and the analog time. This drive signal is transmitted to the analog watch drive unit 216 according to the function related to a constant voltage and the duration thereof, and the corresponding speed and amount of the movement of minute hand of the analog watch.

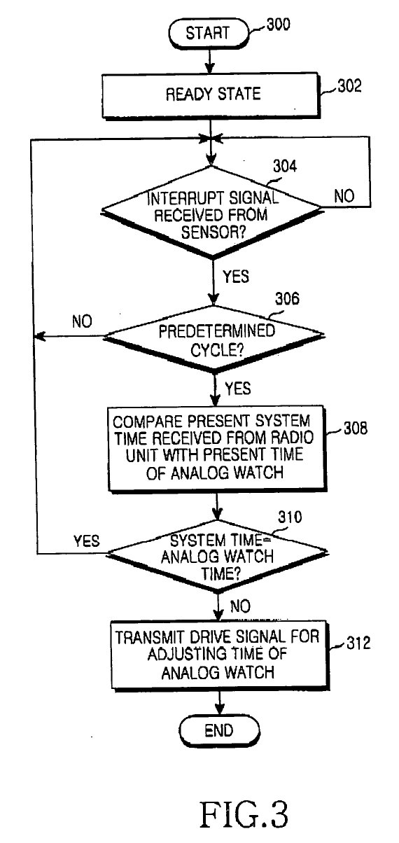

Referring to FIG. 3, the process for automatically and periodically adjusting the time of analog watch 214 to the correct time received from the mobile communication system will now be explained. FIG. 3 is a flow chart for automatically adjusting the time of analog watch in an analog watch-mounted terminal according to a preferred embodiment of the present invention.

First, the control unit 200 maintains the ready state at step 302. When the interrupt signal 304 is inputted from the sensor 212 at step 304, the control unit 200 checks a predetermined cycle at step 306. In other words, the control unit 200 checks how many interrupt signals are input, in order to adjust the time of the analog watch 214. In the case of a predetermined cycle, the control unit 200 advances to step 308 and compares the present system time received from the radio unit with the present analog time. Then, it advances to step 310, and when the system time and the analog time are the same, it advances to step 304 to wait for the input of the interrupt signal from the sensor 212, otherwise it advances to step 312 and outputs to the analog watch drive unit 216 the time-adjusting drive signal for adjusting the time of analog watch to the system time. More particularly, the time-adjusting drive signal transmitted to the analog watch drive unit 216 is a pulse signal obtained by calculating the difference between the system time, and is a present analog time and the time interval needed to adjust to the correct time by moving the minute hand of the analog watch.

Referring to FIG. 4, the process for automatically adjusting the time of analog watch will now be described by way of example, supposing that the sensor 412 is attached to the position capable of sensing the time of twelve o'clock of the analog watch 214. FIG. 4 is a diagram illustrating a process for automatically adjusting the time of analog watch in an analog watch-mounted terminal according to a preferred embodiment of the present invention. As shown in diagram (a) of FIG. 4, when the time of the analog watch 402 arrives at twelve o'clock, the sensor 412 outputs the interrupt signal to the control unit 400, and the control unit 400 checks the present system time. Supposing that the system time stored at the memory unit 204 is a quarter past twelve, the control unit 400 determines that the present analog time needs to be adjusted ahead by a quarter hour, which is the difference between the system time, i.e. a quarter past twelve, and the present analog time, i.e. twelve o'clock. Then, the control unit 400 outputs to the analog watch drive unit 216 a pulse signal to adjust ahead by a quarter hour in order to drive the minute hand of analog watch 402, and as shown in diagram (b) of FIG. 4, the analog watch drive unit 216 receiving the pulse signal drives the minute hand toward the time of a quarter past twelve which is the same as the system time.

Therefore, according to the present invention, the time of the analog watch in an analog watch-mounted terminal can be automatically adjusted to the system time at every cycle sensed by the sensor.

As described above, when the time of analog watch in an analog watch-mounted mobile communication terminal is not correct, the time can be automatically and periodically adjusted to the correct time according to the present invention. On the other hand, the method for adjusting the time by means of a stem according to the prior art has a problem due to a low accuracy. In addition, while it is inconvenient for the user to have to operate the user interface of the terminal directly in order to adjust the time of analog watch to a desired time according to the prior art, it is preferable for the convenience of the user that the time of analog watch can be adjusted automatically and periodically to the correct time obtained by the terminal from the system according to the present invention.

While the invention has been shown and described with reference to certain preferred embodiments thereof, it will be understood by those skilled in the art that various changes in form and details may be made therein without departing from the spirit and scope of the invention as defined by the appended claims.

1. A device for adjusting the time of an analog watch in an analog watch-mounted terminal, comprising:
a radio unit for receiving a system time from a base station;
an analog watch drive unit for driving an hour hand and a minute hand of the analog watch to adjust the time of the analog watch;
a sensor attached at a predetermined position for sensing a predetermined time and outputting an interrupt signal; and
a control unit for comparing the system time with a current analog time and transmitting a drive signal to an analog watch drive unit for adjusting the hour hand and the minute hand according to the difference between the system time and the current analog time, when the interrupt signal is input from the sensor.

2. The device of claim 1, wherein the control unit determines if a predetermined time-adjusting cycle has occurred when the interrupt signal is input, and compares the system time information with the present analog time when the control unit determines that the recognizes a predetermined time-adjusting cycle has occurred.

3. The device of claim 2, wherein the control unit determines that a predetermined time-adjusting cycle has occurred when the interrupt signal is input a predetermined number of times.

4. A method for adjusting the time of an analog watch in an analog watch-mounted terminal that receives a system time from a base station, comprising the steps of:
sensing by a sensor a predetermined time to adjust the time of the analog watch;
determining if a predetermined time-adjusting cycle has occurred when the interrupt signal is input from the sensor; and
comparing the system time with the current analog time, and transmitting a drive signal to a analog watch drive unit adjusting an hour hand and a minute hand according to the difference between the system time and the current analog time.

5. The method of claim 4, wherein the step of determining if a predetermined time-adjusting cycle has occurred, further comprises the step of recognizing a predetermined time-adjusting cycle when the interrupt signal is input a predetermined number of times.
